(19) United States
(12) Patent Application Publication
(10) Pub. No.: US 2010/0026068 A1
(43) Pub. Date: Feb. 4, 2010

(54) APPARATUS FOR TILTING VEHICLE SEAT CUSHION

(75) Inventors: Eom Seok Yoo, Hwaseong-si (KR); Bong Ku Kim, Hwaseong-si (KR); Hak Gyun Kim, Hwaseong-si (KR); Dong Woo Jeong, Hwaseong-si (KR); Gil Ju Kim, Hwaseong-si (KR); Jong Kweon Pyun, Suwon-si (KR); Jun Yeol Heo, Suwon-si (KR); Sang Do Park, Ansan-si (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/323,466

(22) Filed: Nov. 25, 2008

(30) Foreign Application Priority Data
Jul. 31, 2008 (KR) 10-2008-0075218

(51) Int. Cl. B60N 2/02

(52) U.S. Cl. 297/330; 297/313

(57) ABSTRACT

An apparatus for tilting a vehicle seat cushion raises the front end to be higher than the rear end of the seat cushion in order to enhance a supporting force for an occupant seated in a vehicle seat, thereby preventing the occupant from being pushed forwards in the event of sudden braking. The apparatus includes a cushion tilting unit installed in the seat cushion, wherein the cushion tilting unit raises a front end of a seat cushion to be higher than a rear end of the seat cushion without adjusting an angle of the seat back.

### CROSS-REFERENCE TO RELATED APPLICATION

The present application claims the priority of Korean Patent Application No. 10-2008-0075218 filed Jul. 31, 2008, the entire contents of which applications is incorporated herein for all purposes by this reference.

### BACKGROUND OF THE INVENTION

1. Field of the Invention

The present invention relates to an apparatus for tilting a vehicle seat cushion, and more particularly, to an apparatus for tilting a vehicle seat cushion, which can raise the front end to be higher than the rear end of the seat cushion in order to enhance a supporting force for an occupant accommodated in a vehicle seat, thereby preventing the occupant from being pushed forwards in the event of sudden braking.

2. Description of Related Art

A vehicle seat generally includes a seat cushion fixed to a vehicle body to accommodate an occupant and a seat back rotatably mounted to the seat cushion to act as the back of the seat.

FIG. 1 is a perspective view illustrating skeletal frames of a seat cushion and a seat back of a conventional vehicle seat, and FIGS. 2A and 2B are reference views illustrating a variation in the slope of a conventional seat cushion, which takes place when the height of the seat cushion is adjusted.

As shown in FIG. 1, a vehicle seat 10 includes a seat cushion 11 for accommodating an occupant, a seat back 12 pivotally connected to a rear end of the seat cushion 11, and a reclining part 13 for angularly rotating the seat back 12 with respect to the seat cushion 11.

In convenience, in FIG. 1, only the frames of the seat cushion 11 and the seat back 12 are shown with the exterior fabrics removed therefrom in order to explain in detail the interconnecting relationship between the seat cushion 11 and the seat back 12.

The reclining part 13 of the vehicle seat 10 makes it possible to adjust the angle of the seat back 12 with respect to the seat cushion 11 so that an occupant can be comfortably accommodated in the vehicle seat 10.

The seat cushion 11 is also adjustable in height so that occupants having different body sizes and postures can adjust the height of the seat cushion 11 to a position to make them comfortable. As shown in FIGS. 2A and 2B, the height of the seat cushion 11 can be adjusted to be comfortable to the respective occupants.

However, when the height of the conventional vehicle seat cushion 11 is adjusted using a height adjusting mechanism equipped therein, the seat cushion 11 is inclined with the front end thereof set lower than the rear end thereof, as shown in FIGS. 2A and 2B, due to the structural features of the seat cushion 11.

In the inclined seat cushion 11, thighs of the occupant cannot come into close contact with the seat because of an insufficient amount of supporting force, and the occupant is apt to slip from the seat cushion 11. This subsequently causes a very risky situation in which the body of the occupant will be pushed forwards in the event of sudden braking.

While the construction illustrated in FIGS. 1-2B is a manual frame construction in which the height of the seat cushion is manually adjusted, the same problems take place in a power frame construction in which the height of the seat cushion is automatically adjusted. To overcome this problem, a conventional power frame type seat cushion adopted an additional device, which can raise the front end of the seat cushion to a predetermined height. However, this device causes to rotate the entire seat backwards around the rear end of the seat cushion. The seat back is also pulled back, thereby causing a problem in that the occupant has to adjust the angle of the seat back again by rotating the seat back forwards after the front end of the seat cushion was raised.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention provide an apparatus for tilting a vehicle seat cushion, which can raise the front end to be higher than the rear end of the seat cushion in order to enhance a supporting force for an occupant seated in a vehicle seat, thereby preventing the occupant from being pushed forwards in the event of sudden braking.

An aspect of the present invention is directed to an apparatus for tilting a seat cushion of a vehicle seat, which may include the seat cushion and a seat back pivotally mounted to the seat cushion. The apparatus may include a cushion tilting unit installed in the seat cushion, wherein the cushion tilting unit raises a front end of the seat cushion to be higher than a rear end of the seat cushion without adjusting an angle of the seat back.

The cushion tilting unit may include a tilting part placed in the front end of the seat cushion, wherein an rear end of the tilting part may be hinged to a place positioned beyond a front end of a cushion frame of the seat cushion in a rear direction so as to allow a front end of the tilting part to rotate with respect to the rear end of the tilting part, a cross bar coupling the front end of the cushion frame and the front end of the tilting part via a hinge arm and having a predetermined radius of rotation with respect to the front end of the cushion frame so as to lift the front end of the tilting part in a predetermined range of rotation, an external force transmission for applying an external force to the cross bar, and/or an external force generator for supplying the external force to the external force transmission.

The cushion tilting unit further may include a holder displaced on a lower surface of the tilting part and a receiving slot, the holder limiting a movement of the cross bar via the receiving slot. The external force transmission may include a vertical transmission part pivotally connected to the cross bar, and/or a horizontal transmission part pivotally linked to the vertical transmission part and connected to the external force generator. The external force generator may include a drive motor. The external force generator may include an operation lever. The external force generator may be attached to the cushion frame.

The cushion tilting unit may include a tilting part placed in the front end of the seat cushion, wherein an rear end of the tilting part may be hinged to a place positioned beyond a front end of a cushion frame of the seat cushion in a rear direction so as to allow a front end of the tilting part to rotate with respect to the rear end of the tilting part, a cross bar coupling the front end of the cushion frame and the front end of the tilting part via a hinge arm so as to lift the front end of the tilting, an external force transmission for applying an external force to the cross bar, and/or an external force generator for supplying the external force to the external force transmission. The external force transmission may include a vertical transmission part pivotally connected to the cross bar, and/or a horizontal transmission part pivotally linked to the vertical transmission part and connected to the external force generator. The external force generator may include a drive motor. The external force generator may include an operation lever. The external force generator may be attached to the cushion frame.

Another aspect of the present invention is directed to an apparatus for tilting a seat cushion of a vehicle seat, which may include the seat cushion and a seat back pivotally mounted to the seat cushion. The apparatus may include a cushion tilting unit installed in the seat cushion, wherein the cushion tilting unit raises a front end of the seat cushion to be higher than a rear end of the seat cushion without adjusting an angle of the seat back. The cushion tilting unit may further include a tilting part placed in the front end of the seat cushion, wherein an rear end of the tilting part may be hinged to a place positioned beyond a front end of a cushion frame of the seat cushion in a rear direction so as to allow a front end of the tilting part to rotate with respect to the rear end of the tilting part, a cross bar coupling the front end of the cushion frame and the front end of the tilting part via a hinge arm and having a predetermined radius of rotation with respect to the front end of the cushion frame so as to lift the front end of the tilting part in a predetermined range of rotation, an external force transmission for applying an external force to the cross bar, and/or an external force generator for supplying the external force to the external force transmission.

A further aspect of the present invention is directed to an apparatus for tilting a seat cushion of a vehicle seat, which may include the seat cushion and a seat back pivotally mounted to the seat cushion, including a cushion tilting unit installed in the seat cushion, wherein the cushion tilting unit raises a front end of the seat cushion to be higher than a rear end of the seat cushion without adjusting an angle of the seat back. The cushion tilting unit may further include a tilting part placed in the front end of the seat cushion, wherein an rear end of the tilting part may be hinged to a place positioned beyond a front end of a cushion frame of the seat cushion in a rear direction so as to allow a front end of the tilting part to rotate with respect to the rear end of the tilting part, a cross bar coupling the front end of the cushion frame and the front end of the tilting part via a hinge arm so as to lift the front end of the tilting part, an external force transmission for applying an external force to the cross bar, and/or an external force generator for supplying the external force to the external force transmission.

A still further aspect of the present invention is directed to a system for tilting a seat cushion of a vehicle seat, which may include the seat cushion and a seat back pivotally mounted to the seat cushion. The system may include any of the above-described apparatus for tilting the seat cushion of the vehicle seat. Similarly, a passenger vehicle may include any of the above-described apparatus for tilting the seat cushion of the vehicle seat.

According to an aspect of the present invention, the front end of the seat cushion may be tilted without causing to change the angle of the seat back. This as a result can improve the ease and convenience of use of the seat as well as enhance a supporting force for the occupant accommodated in the seat, thereby preventing the occupant from being pushed forwards in the event of sudden braking.

Moreover, the apparatus for tilting a seat cushion of the present invention can be very easily applied to various seats in practice since it is applicable to a variety of frame constructions including a power frame and a manual frame.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view illustrating skeletal frames of a seat cushion and a seat back of a conventional vehicle seat.

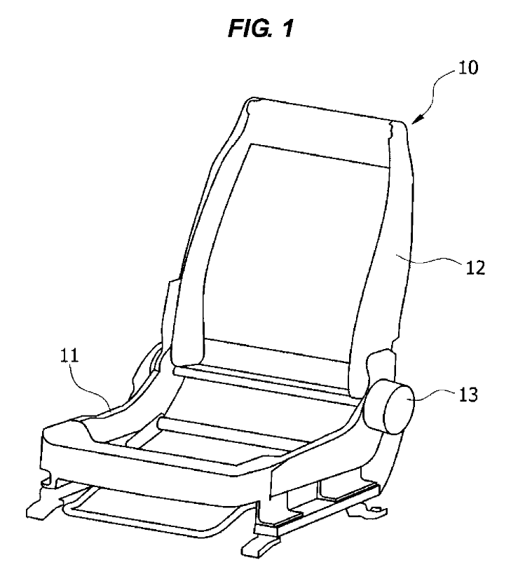

FIGS. 2A and 2B are reference views illustrating a variation in the slope of a conventional seat cushion, which takes place when the height of the seat cushion is adjusted.

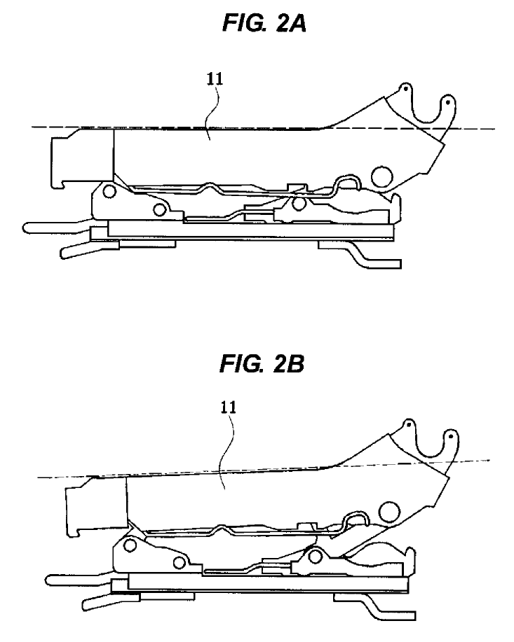

FIG. 3 is a perspective view illustrating an exemplary vehicle seat according to the present invention.

FIG. 4 is a perspective view illustrating an exemplary apparatus for tilting a vehicle seat cushion according to the present invention, which is in a state before tilting.

FIG. 5 is a perspective view illustrating an exemplary apparatus for tilting a vehicle seat cushion according to the present invention, which is in a state after tilting.

FIGS. 6A and 6B are side elevational views of the tilting apparatus of FIGS. 4 and 5.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

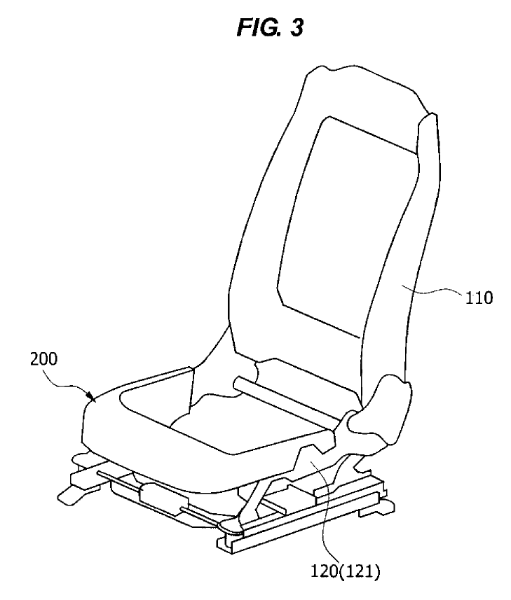

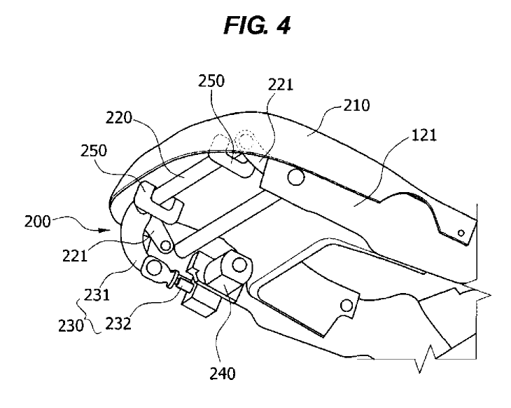

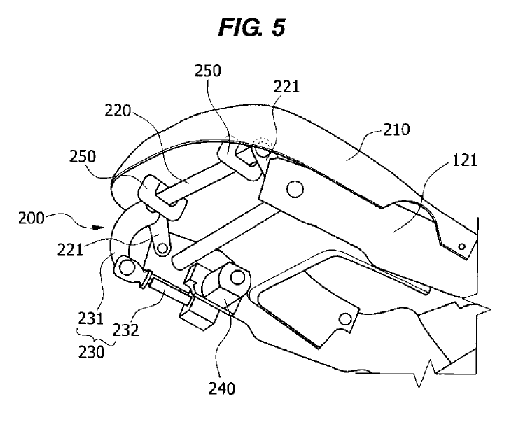

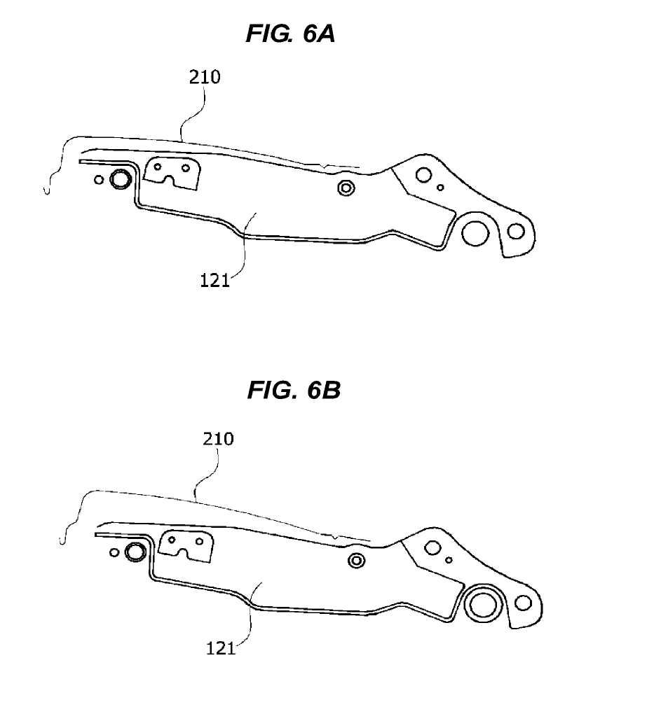

FIG. 3 is a perspective view illustrating an exemplary vehicle seat according to the present invention, FIG. 4 is a perspective view illustrating an exemplary apparatus for tilting a vehicle seat cushion according to the present invention, which is in a state before tilting, FIG. 5 is a perspective view illustrating an exemplary apparatus for tilting a vehicle seat cushion according to the present invention, which is in a state after tilting, and FIGS. 6A and 6B are side elevational view of FIGS. 4 and 5.

Referring to FIGS. 3-5, in a vehicle seat including a seat back 110 and a seat cushion 120, the apparatus for tilting a vehicle seat cushion in various embodiments of the present invention includes a cushion tilting unit 200 installed in a portion of the seat cushion 120. The cushion tilting unit 200 is configured to raise the front end of the seat cushion 120 to be higher than the rear end of the seat cushion 120 without adjusting the angle of the seat back 110.

As detailed in FIGS. 4 and 5, the cushion tilting unit 200 generally includes a tilting part 210, a cross bar 220, an external force transmission 230 and an external force generator 240.

The tilting part 210 is placed in the front part of the seat cushion 120 and is pivotally connected to a rear end of a cushion frame 121 of the seat cushion 120. In detail, the rear end of the tilting part 210 is hinged to the rear end of the cushion frame 121 so that the front end of the tiling part 210 can rotate upwards with respect to the rear end of the cushion frame 121.

When the front end of the tilting part 210 rotates upwards, the tilting part 210 raises the seat cushion 120 loaded thereon so that the front end of the seat cushion 120 becomes higher than the rear end thereof.

The cross bar 220 is installed under the front end of the tilting part 210 to extend in the width direction of the seat. The cross bar 220 is hinged to a front end of the cushion frame 121 via a hinge arm 221 so as to rotate with respect to the cushion frame 121. Here, the front end of the tilting part 210 can be lifted up by rotation of the cross bar 220.

When an external force is applied with a predetermined amount to allow raising the tilting part 210, the cross bar 220 rotates and raises the tilting part 210, which in turn raises the front end of the seat cushion 120.

In various embodiments of the present invention, it may be preferable that holders 250, which limit the movement of the cross bar 220, be installed on the lower surface of the tilting part 210, as shown in the drawings. The cross bar 220 can transmit the external force to the tilting part 210 without the holders 250. However, if the angle of rotation of the cross bar 220 is excessively large, the cross bar 220 may rotate further beyond the upper dead point so that the tilting part 210 will descend again after reached the highest level. It is therefore preferable that the angle of rotation of the cross bar 220 is limited to such a degree that the tilting part 210 can stop at the highest level in various embodiments.

Accordingly, the holders 250 function to limit the angle of rotation of the cross bar 220 so that the tilting part 210 can stop at the highest level and to prevent the cross bar 220 not to be spaced far apart from the tilting part 210 when an external force is not applied.

The external force transmission 230 is constructed to transmit the external force from the external force generator 240 to the cross bar 220, which can rotate under the applied external force.

The external force transmission 230 may be configured as a linear rod if the external force generator 240 having a vertical arrangement is disposed below the cross bar 220. As shown in FIGS. 4 and 5, when the external force generator 240 having a horizontal arrangement is disposed on a cushion frame 121, the external force is transmitted in two directions, i.e., a horizontal direction and a vertical direction.

For this, the external force transmission 230 includes a vertical transmission part 231 hingedly connected to the cross bar 220 and a horizontal transmission part 232 pivotally linked to the vertical transmission part 231. The horizontal transmission part 232 is also connected to the external force generator 240.

Due to this construction, an external force from the external force generator 240 will be applied to the horizontal transmission part 232, which in turn will rotatably push the vertical transmission part 231, which will finally raise the cross bar 220 to rotate pivotally.

As shown in FIGS. 4 and 5, the external force generator 240 can be implemented with a drive motor. In this case, a control switch for operating the drive motor may also be installed around the cushion frame 121.

When the control switch is operated, the drive motor rotates forwards or backwards to lift up or down the frond end of the tilting part 210. The external force generator 240 implemented with the drive motor as described above can be employed in a conventional power frame construction.

The external force generator 240 may be implemented with an operation lever. The operation lever is installed around the cushion frame 121 so that a user can manually push or pull the operation lever to lift up or down the tilting part 210. The external force generator 240 implemented with the operation lever can be employed in a conventional manual frame construction.

The apparatus for tilting a seat cushion according to the present invention can be applied to both the power frame construction and the manual frame construction, which are well known per se in the art. Since the apparatus for tilting a seat cushion of the present invention can cause to easily lift up or down the front end of the seat cushion while keeping the original shape of a frame construction of an existing vehicle seat, its applicability is very high.

Due to the cooperative operation of the external force generator 240, the external force transmission 230 and the cross bar 220 as described above, the front end of the tilting part 210 can be lifted up or down around the hinge, mounted on the rear end of the tilting part 210, as shown in FIGS. 6A and 6B. Accordingly, a supporting force for an occupant accommodated in the seat is greatly increased. Furthermore, the ease and convenience of use is ensured since it is not required to adjust the angle of the seat back 110 when the seat cushion 120 is tilted.

For convenience in explanation and accurate definition in the appended claims, the terms “upper” or “lower”, “front” or “rear”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for tilting a seat cushion of a vehicle seat, which includes the seat cushion and a seat back pivotally mounted to the seat cushion, the apparatus comprising:
a cushion tilting unit installed in the seat cushion, wherein the cushion tilting unit raises a front end of the seat cushion to be higher than a rear end of the seat cushion without adjusting an angle of the seat back.

2. The apparatus according to claim 1, wherein the cushion tilting unit includes:
a tilting part placed in the front end of the seat cushion, wherein an rear end of the tilting part is hinged to a place positioned beyond a front end of a cushion frame of the seat cushion in a rear direction so as to allow a front end of the tilting part to rotate with respect to the rear end of the tilting part;
a cross bar coupling the front end of the cushion frame and the front end of the tilting part via a hinge arm and having a predetermined radius of rotation with respect to the front end of the cushion frame so as to lift the front end of the tilting part in a predetermined range of rotation;
an external force transmission for applying an external force to the cross bar; and
an external force generator for supplying the external force to the external force transmission.

3. The apparatus according to claim 2, wherein the cushion tilting unit further includes a holder displaced on a lower surface of the tilting part and a receiving slot, the holder limiting a movement of the cross bar via the receiving slot.

4. The apparatus according to claim 3, wherein the external force transmission includes:
a vertical transmission part pivotally connected to the cross bar; and
a horizontal transmission part pivotally linked to the vertical transmission part and connected to the external force generator.

5. The apparatus according to claim 4, wherein the external force generator comprises a drive motor.

6. The apparatus according to claim 4, wherein the external force generator comprises an operation lever.

7. The apparatus according to claim 6, wherein the external force generator is attached to the cushion frame.

8. The apparatus according to claim 1, wherein the cushion tilting unit includes:
a tilting part placed in the front end of the seat cushion, wherein an rear end of the tilting part is hinged to a place positioned beyond a front end of a cushion frame of the seat cushion in a rear direction so as to allow a front end of the tilting part to rotate with respect to the rear end of the tilting part;
a cross bar coupling the front end of the cushion frame and the front end of the tilting part via a hinge arm so as to lift the front end of the tilting;
an external force transmission for applying an external force to the cross bar; and
an external force generator for supplying the external force to the external force transmission.

9. The apparatus according to claim 8, wherein the external force transmission includes:
a vertical transmission part pivotally connected to the cross bar; and
a horizontal transmission part pivotally linked to the vertical transmission part and connected to the external force generator.

10. The apparatus according to claim 9, wherein the external force generator comprises a drive motor.

11. The apparatus according to claim 9, wherein the external force generator comprises an operation lever.

12. The apparatus according to claim 11, wherein the external force generator is attached to the cushion frame.

13. An apparatus for tilting a seat cushion of a vehicle seat, which includes the seat cushion and a seat back pivotally mounted to the seat cushion, the apparatus comprising:
a cushion tilting unit installed in the seat cushion, wherein the cushion tilting unit raises a front end of the seat cushion to be higher than a rear end of the seat cushion without adjusting an angle of the seat back;
wherein the cushion tilting unit includes:
a tilting part placed in the front end of the seat cushion, wherein an rear end of the tilting part is hinged to a place positioned beyond a front end of a cushion frame of the seat cushion in a rear direction so as to allow a front end of the tilting part to rotate with respect to the rear end of the tilting part;
a cross bar coupling the front end of the cushion frame and the front end of the tilting part via a hinge arm and having a predetermined radius of rotation with respect to the front end of the cushion frame so as to lift the front end of the tilting part in a predetermined range of rotation;
an external force transmission for applying an external force to the cross bar; and
an external force generator for supplying the external force to the external force transmission.

14. An apparatus for tilting a seat cushion of a vehicle seat, which includes the seat cushion and a seat back pivotally mounted to the seat cushion, comprising:
a cushion tilting unit installed in the seat cushion, wherein the cushion tilting unit raises a front end of the seat cushion to be higher than a rear end of the seat cushion without adjusting an angle of the seat back;
wherein the cushion tilting unit includes:
a tilting part placed in the front end of the seat cushion, wherein an rear end of the tilting part is hinged to a place positioned beyond a front end of a cushion frame of the seat cushion in a rear direction so as to allow a front end of the tilting part to rotate with respect to the rear end of the tilting part;
a cross bar coupling the front end of the cushion frame and the front end of the tilting part via a hinge arm so as to lift the front end of the tilting part;
an external force transmission for applying an external force to the cross bar; and
an external force generator for supplying the external force to the external force transmission.

15. A system for tilting a seat cushion of a vehicle seat, which includes the seat cushion and a seat back pivotally mounted to the seat cushion, the system comprising the apparatus for tilting the seat cushion of the vehicle seat as claimed in claim 1.

16. A system for tilting a seat cushion of a vehicle seat, which includes the seat cushion and a seat back pivotally mounted to the seat cushion, the system comprising the apparatus for tilting the seat cushion of the vehicle seat as claimed in claim 13.

17. A system for tilting a seat cushion of a vehicle seat, which includes the seat cushion and a seat back pivotally mounted to the seat cushion, the system comprising the apparatus for tilting a seat cushion of a vehicle seat as claimed in claim 14.

18. A passenger vehicle comprising the apparatus for tilting the seat cushion of the vehicle seat as claimed in claim 1.

19. A passenger vehicle comprising the apparatus for tilting the seat cushion of the vehicle seat as claimed in claim 16.

20. A passenger vehicle comprising the system for tilting the seat cushion of the vehicle seat as claimed in claim 17.
